(19) United States
(12) Patent Application Publication
(10) Pub. No.: US 2006/0174191 A1
(43) Pub. Date: Aug. 3, 2006

(54) Information processing apparatus and method and storage medium storing information processing program

(75) Inventor: Yoji Kudo, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/218,505

(22) Filed: Sep. 6, 2005

(30) Foreign Application Priority Data
Jan. 28, 2005 (JP) 2005-021122

(51) Int. Cl. G06F 17/24

(52) U.S. Cl. 715/512

(57) ABSTRACT

This invention provides an information processing apparatus including a display that displays document data and an annotation attached to the document data and a display controller that controls how and where the annotation is displayed, and when a display position of the annotation is fixed, causes the display to indicate that the display position of the annotation is fixed.

### BACKGROUND OF THE INVENTION

1. Field of the Invention

The present invention relates to an information processing apparatus, method, and information processing program for improved management of document data and annotations attached to document data.

2. Description of the Related Art

Heretofore, information processing devices that manage documents, images, and the like on the computer without outputting them on paper have been in practical use. Such information processing devices may be provided with the capability of storing document data to be managed on a recording medium of the computer, attaching annotations, i.e., annotation image data to the document data, and showing the annotations.

However, in such information processing devices, even if the user performs operation to fix a position where an annotation should be displayed, the result of the operation is not shown and how the annotation is now is not easily perceptible for the user.

### SUMMARY OF THE INVENTION

The present invention has been made in view of the above problem and provides an information processing apparatus, method, and information processing program offering enhanced usability of annotation.

According to an embodiment of the present invention, an information processing apparatus includes a display that displays document data and an annotation attached to the document data and a display controller that controls how and where the annotation is displayed. When a display position of the annotation is fixed, the display controller causes the display to indicate that the display position of the annotation is fixed.

According to another embodiment of the present invention, an information processing method includes displaying document data and an annotation attached to the document data, controlling how and where the annotation is displayed, and indicating that a display position of the annotation is fixed when the display position of the annotation is fixed.

According to still another embodiment of the present invention, a storage medium readable by a computer stores an information processing program including instructions causing a computer to display document data and an annotation attached to the document data, to control how and where the annotation is displayed, and to indicate that a display position of the annotation is fixed when the display position of the annotation is fixed.

### BRIEF DESCRIPTION OF THE DRAWINGS

The above and other aspects, features, and advantages of the present invention will be more apparent from the following description of an illustrative embodiment thereof, taken in conjunction with the accompanying drawings, wherein:

FIG. 1 is a block diagram of a configuration of an information processing apparatus according to an embodiment of the present invention;

FIG. 2 shows an example of a screen displayed on a display shown in FIG. 1;

FIG. 3 is a flowchart describing an example of an operation to fix the position where an annotation should be shown in the information processing apparatus of the illustrative embodiment; and

FIG. 4 is a flowchart describing an example of an operation to move the position where an annotation should be shown in the information processing apparatus of the illustrative embodiment.

### DETAILED DESCRIPTION OF THE INVENTION

An embodiment of the invention will now be described in accordance with the drawings.

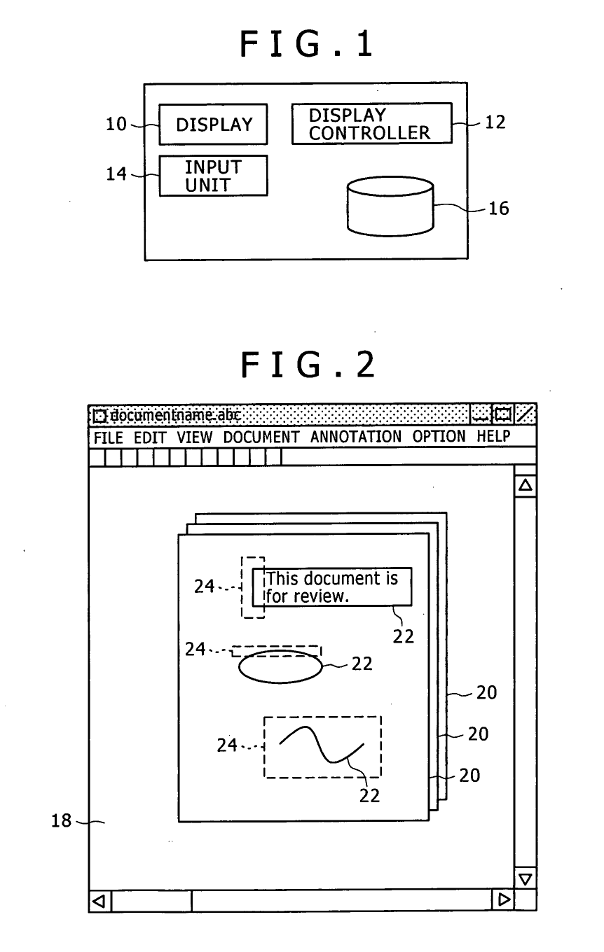

FIG. 1 shows a block diagram of a configuration of an information processing apparatus according to an embodiment of the present invention. In FIG. 1, the information processing apparatus includes a display 10, a display controller 12, an input unit 14, and a memory 16.

The display 10 is embodied in, for example, a CRT, a liquid crystal display, etc. and displays text data, numerical data, various kinds of figures, pictorial symbols, photos, etc. included in document data and an annotation.

The display controller 12 controls the operation of the display 10 to display document data, an annotation, and other data. In particular, the display controller 12 controls how and where an annotation is shown including annotation form, color, and presence/absence of text information. When a display position where an annotation should be displayed is fixed, the display controller 12 controls the display 10 to show a fix indication which indicates that the display position of the annotation is fixed. It also controls how a fix indication is shown, that is, the form, color, degree of transparency, etc. of the fix indication.

The input unit 14 includes a keyboard, a mouse or the like which can be used to select a space, and a scanner, etc. The input unit 14 is used by the user to input various kinds of data to the information processing apparatus. Attaching an annotation to document data, fixing a position where the annotation should be displayed, and canceling the fixation of the display position are also performed with the input unit 14.

The memory 16 is composed of, for example, a RAM serving as a working area for the CPU, an EEPROM as a nonvolatile memory, a magnetic storage medium, etc. Data and programs relating to a document, an annotation, and a fix indication are stored in the memory 16.

The above information processing apparatus may be a computer built up of the CPU and other elements. In this case, the CPU executes a program stored in a hard disk or other storage media to realize a function of the information processing apparatus.

FIG. 2 shows an example of a screen displayed on the display 10 shown in FIG. 1. In FIG. 2, document data 20 is displayed on the screen 18 and annotations 22 which are annotation image data for the document are attached to this document data 20. Here, when the display positions of the annotations 22 are fixed by user operation via the input unit 14, fix indications 24 visualizing that the display positions of the annotations 22 are fixed are superimposed on the annotations 22. Thereby, the user can readily confirm that the display positions of the annotations 22 have been fixed by the operation via the input unit 14.

The above fix indications 24 may be shown in, for example, an adhesive tape-like form. This simulates taping something with adhesive tape, which is familiar in the real world, and the annotations 22 that become intuitively perceptible and more usable for the user can be realized.

The above fix indications 24 may be transparent. This can prevent hiding the annotations 22 themselves to be shown, so that the user can view the annotations 22.

Moreover, the above fix indications 24 may be colored, so that the user can easily recognize where the fix indications 24 are.

The above-described fix indications 24 may be superimposed over a part or all of each of the annotations 22. In this embodiment, the fix indications 24 and the annotation 22 cannot be moved or deleted unless the fixation of the display positions of the annotations is canceled. Canceling the fixation of the display positions of the annotations 22 is also performed via the input unit 14.

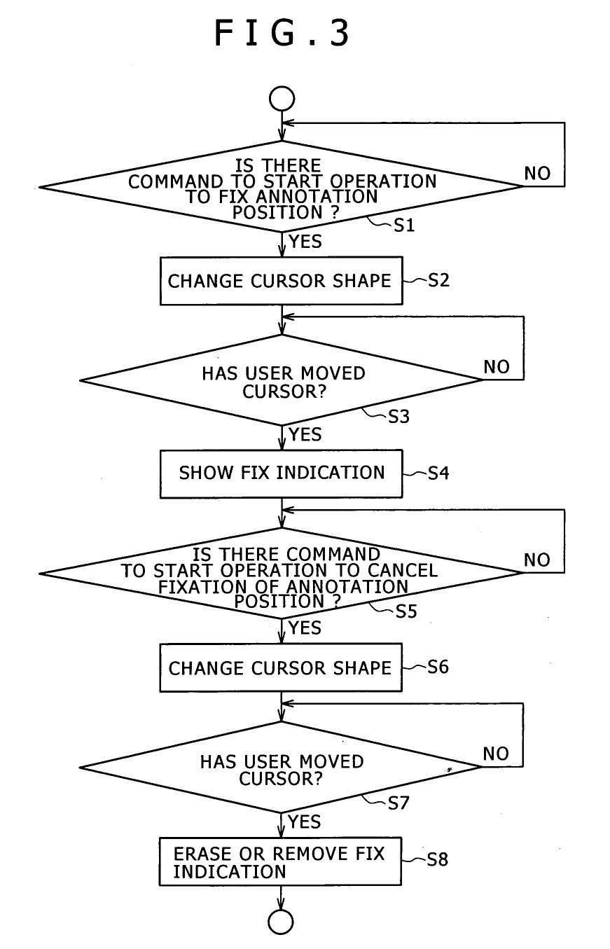

FIG. 3 shows a flowchart describing an example of operations to fix the display position of the annotation 22, and to cancel the fixation in the information processing apparatus of this embodiment.

In FIG. 3, when the user starts the operation to fix a position where an annotation 22 should be shown by operating the input unit 14 composed of the keyboard, mouse, etc. (S1), the display controller 12 changes the cursor shape appearing on the screen 18 displayed on the display 10 (S2). The cursor shape can be changed, for example, from a blinking rectangle to an arrow.

Then, the user moves the shape-changed cursor by operating the input unit 14 (S3). Moving the cursor can be done, for example, by dragging the mouse of the input unit 14. The display controller 12 shows a fix indication 24 drawn as the cursor is moved on the specified annotation 22 (S4). Information about the fixed position where the annotation 22 should be shown is stored into the memory 16.

If the fix indication 24 is shown in, for example, the adhesive tape-like form, it may be displayed as if adhesive tape were attached onto the annotation 22 as the cursor is moved. This can make it intuitively perceptible for the user that the display position of the annotation 22 is fixed.

By the above operation, the display position where the annotation 22 should be shown has been fixed, the fixed position being visualized by the fix indication 24.

Next, when the user starts the operation to cancel the fixation of the annotation 22 by operating the input unit 14 (S5), the display controller 12 changes the cursor shape appearing on the screen 18 displayed on the display 10 (S6). The cursor shape can be changed in the same way as for S2.

Then, the user moves the shape-changed cursor along the fix indication 24 to cancel the fixation by operating the input unit 14 (S7). Instead of moving the cursor, it may also be employed to position the cursor on the fix indication 24 and click with the mouse or click and drag the cursor to a desired position.

As the cursor is moved or clicked and dragged with the mouse in this way, the display controller 12 controls the display on the display 10 to erase the fix indication 24 shown on the specified annotation 22 or move the fix indication from the annotation 22 to another position (S8). Information about the cancel of the fixation of the display position of the annotation 22 is stored into the memory 16.

The operations to fix the display position of the annotation 22 and to cancel the fixation are executed in the manner described above.

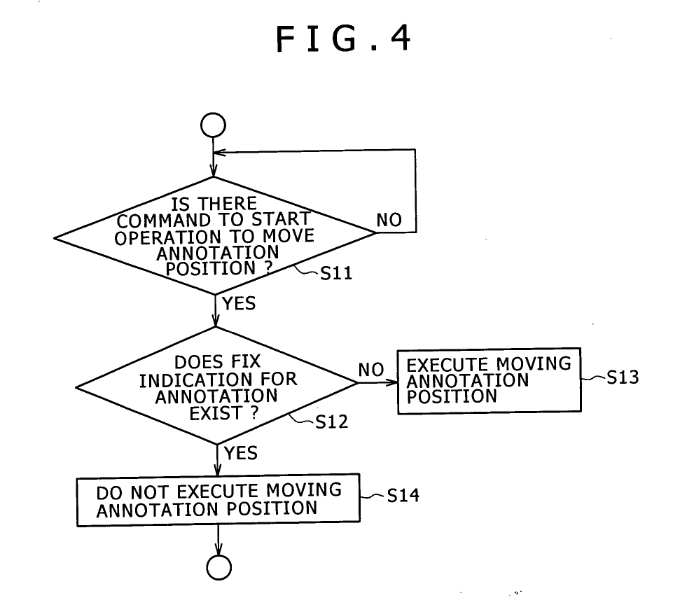

FIG. 4 shows a flowchart describing an example of an operation to move the display position where an annotation 22 should be shown in the information processing apparatus of this embodiment. In FIG. 4, when the user issues a command to start the operation to move the display position of the annotation 22 by operating the input unit 14 (S11), the display controller 12 determines whether the fix indication 24 is displayed on the annotation 22 (S12). If the fix indication 24 does not exist, the display controller 12 executes moving the display position of the annotation 22 (S13). Distance by which the position will be moved is determined by, for example, how long the mouse of the input unit 14 is dragged.

If the fix indication 24 exists as determined at S12, the display controller 12 does not execute moving the display position of the specified annotation 22 (Sl4).

In the manner described above, the move operation can be arranged such that moving the display position of the annotation 22 can be executed if the fix indication 24 does not exist on the annotation 22, but cannot be executed if the fix indication 24 exists on the annotation 22. At this time, the user can easily know whether the annotation 22 can be repositioned, depending on whether the fix indication 24 for that annotation is shown in the screen 18 displayed on the display 10.

As described above, the present invention resides in an information processing apparatus including a display that displays document data and an annotation attached to the document data and a display controller that controls how and where the annotation is shown, wherein the display controller, when a display position of the annotation is fixed, causes the display to show fix indication visualizing that the display position of the annotation is fixed.

The fix indication may be shown in a transparent tape-like form, superimposed over a part or all of each of the annotations, and may be colored.

The present invention also resides in an information processing method including displaying document data and an annotation attached to the document data, controlling how and where the annotation is shown, and, when a display position where the annotation should be shown is fixed, showing a fix indication visualizing that the display position of the annotation is fixed.

The present invention also resides in a storage medium readable by a computer, the storage medium storing an information processing program including instructions causing a computer to display document data and an annotation attached to the document data, control how and where the annotation is shown, and, when a display position where the annotation should be shown is fixed, show fix indication visualizing that the display position of the annotation is fixed.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art.

The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-021122 filed on Jan. 28, 2005 including specification, claims, drawings and abstract is incorporated herein by reference in its entirety.

What is claimed is:

1. An information processing apparatus comprising:
a display that displays document data and an annotation attached to the document data; and
a display controller that controls how and where the annotation is displayed, and when a display position of the annotation is fixed, causes the display to indicate that the display position of the annotation is fixed.

2. The information processing apparatus according to claim 1, wherein the indication of the fixation of the display position of the annotation is shown in a transparent tape-like form, superimposed over a part or all of the annotation.

3. The information processing apparatus according to claim 2, wherein the indication is shown in a color tape-like form.

4. An information processing method comprising:
displaying document data and an annotation attached to the document data;
controlling how and where the annotation is displayed; and
indicating that a display position of the annotation is fixed when the display position of the annotation is fixed.

5. A storage medium readable by a computer, the storage medium storing an information processing program comprising instructions causing a computer to:
display document data and an annotation attached to the document data;
control how and where the annotation is displayed; and
indicate that a display position of the annotation is fixed when the display position of the annotation is fixed.

6. The method according to claim 4, wherein:
the indication of the fixation of the display position of the annotation is shown in a transparent tape-like form, superimposed over a part or all of the annotation.

7. The method according to claim 6, wherein:
the indication is shown in a color tape-like form.

8. The storage medium according to claim 5, wherein:
the indication of the fixation of the display position of the annotation is shown in a transparent tape-like form, superimposed over a part or all of the annotation.

9. The storage medium according to claim 8, wherein:
the indication is shown in a color tape-like form.

10. The information processing apparatus according to claim 1, wherein:
the annotation cannot be moved or deleted unless the fixation of the display position of the annotation is canceled.

11. The method according to claim 4, wherein:
the annotation cannot be moved or deleted unless the fixation of the display position of the annotation is canceled.

12. The storage medium according to claim 5, wherein:
the annotation cannot be moved or deleted unless the fixation of the display position of the annotation is canceled.
